(19) United States
(12) Patent Application Publication
(10) Pub. No.: US 2006/0060511 A1
(43) Pub. Date: Mar. 23, 2006

(54) Automatic weighting system for variable weight items

(75) Inventors: Yakasovic Tomas, Catemu (CL); Tomasello Gonzalo, Catemu (CL)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YT INGENIERIA LTDA.

(21) Appl. No.: 11/200,178

(22) Filed: Aug. 10, 2005

(30) Foreign Application Priority Data
Aug. 10, 2004 (CL) 2032-2004

(51) Int. Cl. B07C 5/16; G01G 9/00

(52) U.S. Cl. 209/592; 53/502; 702/173; 177/25.13

(57) ABSTRACT

This invention relates to systems for assisting in the packaging of units or clusters of products having variable weights, thus permitting forming with high precision and efficiency, various weight configurations, and further, providing complete traceability of the packing process. In combination with a decision-making electronic device, determining the most suitable distribution or position for each unit or cluster within a position's matrix, wherein the system combines the units or clusters of the product for completing the required packed weight. In combination with a visualization and operation device, it configures the system, and it permits at the same time, visualizing, scheming, illustrating or plotting the position's matrix, thus distributing there from each unit or cluster analyzed by the data-entering device, that permits a highly accurate weighting of each individual unit or cluster, thus enhancing the yield and reducing significantly the packing time.

This invention relates to systems for assisting in the packaging of units or clusters of products having variable weights, thus permitting forming with high precision and efficiency, various weight configurations, and further, providing complete traceability of the packing process.

### BACKGROUND OF THE INVENTION

Presently, the usual packing system for variable weight products such as fruits and vegetables (i.e. grape's clusters) is made by trained handworkers, which must select the products from a conveyor belt and accumulating several units until completing approximately the required weight. In this system, widely used by producers and distributors of different variable weight products, the workers must reduce or prune the selected clusters, according to their own capacity and criteria, in order to adjust the items to a predetermined, suitable weight for packaging. The whole procedure would result a slow one, originating cluster losses, a constant loss of the product, and weight differences in the finished packaged products.

The South African packaging system, known in the market, comprises a set of baskets containing fruit clusters grouped by weight categories, in other words, baskets containing clusters with weights in the range of 200 up to 250 grams, others ranging between 250 and 300 grams, and so on, depending on the necessary ranges. The user may define the ranges. The equipment receives a fruit loaded basket which is placed on a scale and weighed (the baskets are filled by other workers). Then, the system determines if the weight is within the range. If it is not, it provides an indication to the operator, with instructions prompting the worker to extract any cluster from the basket, which will be classified inside another basket containing clusters with the same weight as the one withdrawn from the basket. Then, the system instructs the worker to withdraw a cluster from another basket containing clusters with the necessary weight for completing the weight of the first basket. The same worker closes the basket and sends it for completing the packaging. The problems with this equipment are that, due to detached grains from the cluster's rachis in the classification basket, the cluster may result with an incorrect weight, thus causing a weighting error. On the other hand, in order to deliver the predetermined quantity of fruit, the weight ranges of each basket shall be narrow. This might result in an important increase in the number of baskets, making the system difficult to operate.

Another known development in this field includes a matrix of hooks for hanging pre-weighed clusters and, when the. matrix has enough units, the system provides indications on what clusters are to be withdrawn simultaneously for completed the required weight. This system also has de disadvantage of the quantity of positions, difficulting the operation.

In order to address these problems, an automated weighting system was developed for assisting in the packaging of units or clusters of variable weight, as can be the case generally with fruits and vegetable products, and more particularly, with grapes clusters of several varieties, or additionally with several meat cuttings. The systems avoids losses such as the, often necessary cuttings, for adjusting the desired weight of each package. It is noted that, in the case of grapes clusters, the losses are limited to clusters having less weight than the desired one and from the usual detachment of the berries. The main characteristic of the proposed system consists in that, by using a predicting algorithm, it permits to load directly the baskets or bags thus completing the required weight, starting from individual weightings of the clusters, without the need for separately storing them.

### BRIEF DESCRIPTION OF THE DRAWINGS

A practical example illustrating present invention consists of the accompanying drawings, intended only as illustrations but not as limitations, in which:

FIG. 1 represents an isometric front view of a workstation.

FIG. 2 illustrates an isometric back view of the workstation of FIG. 1.

FIG. 3 shows a schematic view of the panel for visualizing and operating the system.

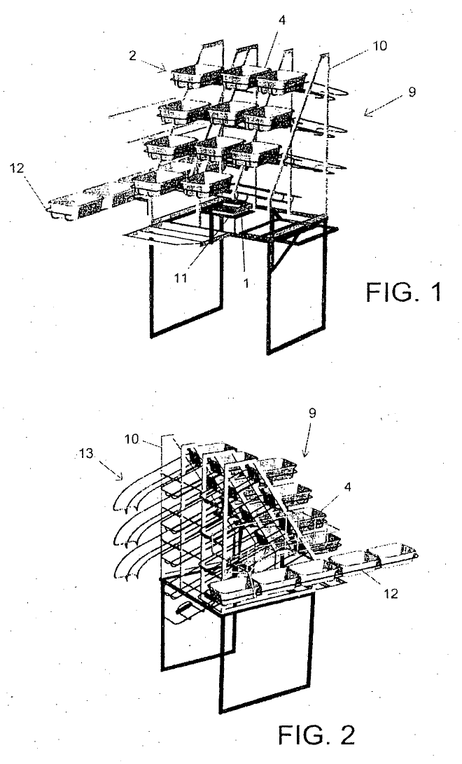

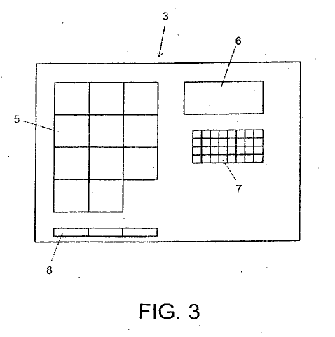

### DETAILED DESCRIPTION OF THE PREFERRED EMBODIMENTS

Present invention comprises an automated weighing system for assisting in packaging units or clusters of variable weight products, in example, fruits and vegetable products in general and more particularly, grape clusters of several varieties, as well as the various meat cuttings. The main advantage of the system is the reduction of losses due to the adjustment of the necessary weights pursuant the predetermined individual weight, comprising:

a) a data-entering device (1), such as a weighting station comprising an instrument that permits determining the individual weight of each unit or cluster in combination with;

b) an electronic decision making device, that permits determining the most suitable distribution or position for each unit or cluster of the product within the position's matrix (2), in that the system combines the necessary units or clusters of the product to complete the required weight;

c) a visualization and operation device (3), that permits configuring and controlling, scheming, illustrating or plotting the system's operation matrix (2). By distributing therefrom, by automated or manual means, each of the units or clusters analyzed by the data-entering device (1); it provides a very accurate weighting system for each package, optimizing the product yield and substantially reducing the packing time.

More particularly, the data-entering device (1) comprises a scale or any other similar weighting means.

Similarly, the position's matrix comprises a series of packing elements (4), which can be stiff such as trays, baskets, containers, etc., or pliable such as bags.

The visualization and operation device (3) comprises a panel (or screen) including at least an area with indicia on the system's information (6) and a keyboard for configuring the operation (7). Further, there is an area with auxiliary operation indicators (8). The visualization and operation device (3) may be a computer screen, an electronic screen, a television set screen or any similar electronic device.

According to a preferred embodiment of the invention, the visualization and operation device (3) allows visualization of filling indicia, such as red colored signals, when the electronic device determines that some of the packing elements (4), included in the position's matrix (2) had been loaded with the right predetermined weight. Additionally, it permits the operator to see indication signals, such as green colored ones, corresponding to packing elements (4) being simultaneously loaded with several units or clusters of the product, as far as the electronic device determines that said packing elements (4) do not reach the predetermined weight.

According with a practical embodiment of the proposed system, a work-station is provided (9) comprising the above described parts (a, b, and c) in combination with:

d) a structure (10) supporting a position's matrix (2) configured with 2 up to 20 packing elements (4);

e) a lateral support for the box of fruit to be processed;

f) a support for the data-entering device;

g) a support for the visualization and operation device (3);

h) an in-line recirculation device (12) of the packing elements (4) entering empty, by automated or manual means, to the position's matrix (2);

i) an own energy source, such as a rechargeable battery, providing autonomy in case of an electric energy network failure, thus avoiding losses on the information accumulated during the process:

j) a return line conduction system (13) for the packing elements (4), which after being completed are carried, by automated or manual means, from the position's matrix (2) to the packing area;

k) a packing station; and

l) a general purpose software installed at the office, which permits visualization in real time of the equipment's operation, and also, its programming.

According to another practical embodiment of the proposed system, at least two workstations (9) are provided in parallel, each one separately comprising all the above describe parts [(a) to (i)], sharing the parts designed with letters a) to (I).

Additionally, by using two workstations (9) in parallel, it enables mixed packing, i.e. mixed fruits such as two different grape varieties or processing at the same time, i.e. peaches and apples, with a high weight accuracy.

Further, the system provides a complete traceability of the packing process, with on-line information available by connection to computers.

The system saves constantly the process information from each workstation (9) providing statistics on the efficiency of the operation, as well as from the accomplished work. The user can use these data for several purposes, i.e. facilitating payments, in the case of work payments by production. The system further includes outgoing data ports for connecting on-line the workstations (9) with the software controlling and administering the process included with the system. This system permits to visualize, i.e. in a computer connected with the equipment, the performance in real time for each of the workstations (9) in the packinghouse. In case it does not work on-line with the workstations (9), the device can be detached from each station (9), thus discharging its information to a PC.

For other features, the system uses a keyboard permitting the user to obtain process information, and the packing manager entering the required parameters for the operation (password protected). With the system connected on-line, these parameters may be entered remotely from a computer.

The system can be manually operated or be a fully automated one.

In manual mode, the operation is very simple. All the operator has to do is placing only one unit or cluster of the product into de entering device (1), and then, placing it in one of the packing elements (4) within the position's matrix, indicated by the electronic decision making device. By repeating it successively, the operator processes a new unit or cluster of the product, until the visualization and operation device (3) indicates that one packing element (4) reached the required weight. Then, it is forwarded to the following step (normally, the packing-station). A new packing element (4) replaces the completed one, thus continuing the weighting operation.

In the automated mode, the system operates with one or more robotic arms, conveyor belts or other technologies.

What is claimed is:

1. An automated weighting system for assisting in the packing of units or clusters of a variable weight products, in that it basically comprises a data entering device such as a weighting station, determining the individual weight of each unit or cluster of the product;
in combination with a decision-making electronic device, determining the most suitable distribution or position for each unit or cluster within a position's matrix, wherein the system combines the units or clusters of the product for completing the required packed weight; wherein in combination with a visualization and operation device, it configures the system;
it permits at the same time, visualizing, scheming, illustrating or plotting the position's matrix, thus distributing therefrom each unit or cluster analyzed by the data-entering device;
the system provides a highly accurate weighting of each individual unit or cluster, thus enhancing the yield and reducing significantly the packing time.

2. The automated weighting system according to claim 1, in that it comprises a very simple operation;
the operator places only a unit or cluster at a time in the entering device, then places the unit or cluster inside the packing element within the position's matrix, until as indicated by the decision-making device, and so on with a new unit or cluster of the product;
the visualization and operation device will indicate when the packing element complies with the required weight; and
the packing element goes to the next step, normally a packing-station, and a new packing element replaces the processed one.

3. The automated weighting system for assisting in packing units or clusters having variable weights, according to claim 1, in that it can be operated by one or more robotic arms, conveyor belts or other technologies.

4. The automated weighting system for assisting in packing units or clusters having variable weights, according to claim 1, in that the data-entering device includes a scale.

5. The automated weighting system for assisting in packing units or clusters having variable weights, according to claim 1, in that the data-entering device includes a balance.

6. The automated weighting system for assisting in packing units or clusters having variable weights, according to claim 1, in that the position's matrix comprises a series of stiff packing elements, such as trays, baskets, containers or boxes.

7. The automated weighting system for assisting in packing units or clusters having variable weights, according to claim 1, in that the position's matrix includes a series of pliable elements, such as bags.

8. The automated weighting system for assisting in packing units or clusters having variable weights, according to claim 1, in that the visualization and operation device comprises a panel including at least an area providing operation's indicia referring to the position's matrix, an area with system information and a configuration and operating keyboard.

9. The automated weighting system for assisting in packing units or clusters having variable weights, according to claim 8, in that the visualization and operation device further includes an area with auxiliary operation's indicia.

10. The automated weighting system for assisting in packing units or clusters having variable weights, according to claim 1, in that the visualization and operation device can be a computer monitor, an electronic screen, a television screen or any similar electronic means.

11. The automated weighting system for assisting in packing units or clusters having variable weights, according to claim 1, in that the visualization and operation device exhibits completed weight signals, such as red signals, when the electronic device determines that some of the packing elements included in the position's matrix complies with the predetermined weight.

12. The automated weighting system for assisting in packing units or clusters having variable weights, according to claim 1, in that the visualization and operation device exhibits indication's signals, such as green signals corresponding to simultaneously loading packing elements that, according to the electronic device, did not reach the predetermined weight.

13. The automated weighting system for assisting in packing units or clusters having variable weights, according to claim 1, in that it is integrated in a workstation comprising a support structure supporting the position's matrix with at least 2 packing elements.

14. The automated weighting system for assisting in packing units or clusters having variable weights, according to claim 1, in that it is integrated with a workstation comprising a structure supporting up to 20 packing elements.

15. The automated weighting system for assisting in packing units or clusters having variable weights, according to claim 1, in that it is integrated in a workstation comprising a lateral support for a box of fruit being processed.

16. The automated weighting system for assisting in packing units or clusters having variable weights, according to claim 1, in that it is integrated in a workstation comprising a support for the entering device.

17. The automated weighting system for assisting in packing units or clusters having variable weights, according to claim 1, in that it is integrated in a workstation comprising a support for the visualization and operation device.

18. The automated weighting system for assisting in packing units or clusters having variable weights, according to claim 1, in that it is integrated with an in-line recirculation device for the empty packing elements, by manual or automated means, that return to the position's matrix.

19. The automated weighting system for assisting in packing units or clusters having variable weights, according to claim 1, in that it is integrated in a workstation comprising an in-line return conduction system for the packing elements that, once loaded are transported, by automated or manual means, from the position's matrix towards the packing-station.

20. The automated weighting system for assisting in packing units or clusters having variable weights, according to claim 1 in that it is integrated in a workstation comprising a self-sufficient energy device such as a rechargeable battery for making it independent from electric network failures, thus avoiding information loses accumulated during the packing process.

21. The automated weighting system for assisting in packing units or clusters having variable weights, according to claim 1, in that it is integrated in at least two workstations connected in parallel, each one comprising a structure supporting a position's matrix comprising from 2 up to 20 packing elements.

22. The automated weighting system for assisting in packing units or clusters having variable weights, according to claim 1, in that it is integrated in at least two workstations connected in parallel, each one comprising a lateral support for the box of fruit to be processed.

23. The automated weighting system for assisting in packing units or clusters having variable weights, according to claim 1, in that it is integrated with at least two workstations connected in parallel, each one comprising a support for the entering device.

24. The automated weighting system for assisting in packing units or clusters having variable weights, according to claim 1, in that it is integrated with at least two workstations connected in parallel, each one comprising a support for the visualization and operation device.

25. The automated weighting system for assisting in packing units or clusters having variable weights, according to claim 1, in that it is integrated in at least two workstations connected in parallel, sharing an in-line recirculation device for the packing elements entering empty, by automated or manual means, towards the position's matrix.

26. The automated weighting system for assisting in packing units or clusters having variable weights, according to claim 1, in that it is integrated in at least two parallel workstations, sharing a packing-station.

27. The automated weighting system for assisting in packing units or clusters having variable weights, according to claim 1, in that it is integrated in at least two workstations connected in parallel, sharing a general control software installed at the office, permitting visualization in real time the operation of the equipment and its programming.

28. The automated weighting system for assisting in packing units or clusters having variable weights, according to any of claims 21 to 27, in that by using two workstations connected in parallel, it permits mixed packing, such as two grape varieties or mixing in the same process different fruits such as peaches and apples, with high precision weighting.

29. The automated weighting system for assisting in packing units or clusters having variable weights, according to claim 1, in that it can be connected with at least one computer, providing complete traceability of the packing process.

30. The automated weighting system for assisting in packing units or clusters having variable weights, according to any of claims 1 to 29, in that it applies generally to vegetable products.

31. The automated weighting system for assisting in packing units or clusters having variable weights, according to any of claims 1 to 29, in that it applies generally to fruit products.

32. The automated weighting system for assisting in packing units or clusters having variable weights, according to any of claims 1 to 29, in that it applies to grape clusters, avoiding losses due to cuttings for adjusting each package to the predetermined weight.

33. The automated weighting system for assisting in packing units or clusters having variable weights, according to any of claims 1 to 29, in that it applies to different meat cuttings.
